(19) United States
(12) Patent Application Publication
(10) Pub. No.: US 2022/0278395 A1
(43) Pub. Date: Sep. 1, 2022

(54) POUCH CELL

(71) Applicant: HONDA MOTOR CO., LTD., Tokyo (JP)

(72) Inventors: Masahiro Ohta, Wako-shi (JP); Takuya Taniuchi, Wako-shi (JP)

(21) Appl. No.: 17/578,507

(22) Filed: Jan. 19, 2022

(30) Foreign Application Priority Data
Feb. 26, 2021 (JP) 2021-030656

(51) Int. Cl. H01M 50/105; H01M 50/533

(52) U.S. Cl. CPC H01M 50/105; H01M 50/533

(57) ABSTRACT

A pouch cell includes: a storage discharge element having a substantially cuboid shape; a power collection tab lead that is thinner than the storage discharge element and is externally drawn from the storage discharge element; and an exterior film that packages the storage discharge element in a state where the power collection tab lead is externally drawn, wherein the exterior film includes: a holding part that sandwiches the power collection tab lead from front and rear surfaces in a thickness direction; a fold part along an outline of the holding part; and a reinforcement part that is folded from the fold part and is joined to at least the holding part, the fold part is joined to a side portion that extends in a thickness direction of the holding part, the reinforcement part is folded back in a direction of sandwiching the power collection tab lead by the fold part, and the reinforcement part includes an extension portion that extends from the fold part along a drawn direction of the power collection tab lead or a direction that crosses the drawn direction.

### CROSS-REFERENCE TO RELATED APPLICATION

Priority is claimed on Japanese Patent Application No. 2021-030656, filed on Feb. 26, 2021, the contents of which are incorporated herein by reference.

### BACKGROUND

### Field of the Invention

The present invention relates to a pouch cell such as a battery.

### Background

In recent years, demands for a high-capacity and high-output battery have rapidly expanded due to the popularization of various large and small electrical and electronic apparatuses such as an automobile, a personal computer, and a mobile phone. Examples of such a battery include a liquid-system battery cell in which an organic electrolysis solution is used as an electrolyte between a positive electrode and a negative electrode, a solid-state battery cell in which a flame retardant solid electrolyte in a solid state is used instead of the electrolyte of the organic electrolysis solution, and the like.

As a solid-state battery, a laminated cell-type pouch cell is known in which a cell having a cuboid shape is wrapped by a laminated film and sealed in a plate shape. By wrapping the cell with an exterior body (film), moisture and air are prevented from entering the battery.

For example, Japanese Unexamined Patent Application, First Publication No. 2003-242942 discloses a pouch cell in which such a film is wrapped around a battery main body and packages the battery main body. Here, it is disclosed that an extension end part 7 is provided at the circumference edge of a laminate body (a package material for a lithium ion battery) 10 that constitutes an exterior film (exterior body) P, a cross-section F1 is covered by the extension end part 7 by folding back and thermally bonding the extension end part 7, and entry of moisture from the cross-section F1 is prevented.

### SUMMARY

However, in the pouch cell, in a portion having a triangular column shape in which a power collection tab and a lead are enclosed, only the exterior film protects a joint part between the power collection tab and the lead. Therefore, it is desired to enhance the strength of the portion.

Further, Japanese Unexamined Patent Application, First Publication No. 2003-242942 does not disclose that the strength around the power collection tab and the lead is improved, and there is room for improvement in this regard.

Further, since there is a gap at a part (a lead-holding part) that holds the power collection tab and the lead in the exterior film, there is a possibility that water or air may enter the gap. In order to prevent this, a long seal part is formed in most cases. However, in such a structure, there is a possibility that a problem such as an energy density decrease of the battery cell may occur.

An object of an aspect of the present invention is to improve the strength around a joint part between a power collection tab and a lead, improve the airtightness in a pouch cell, prevent an energy density from decreasing, and prevent the number of components from increasing.

A pouch cell according to a first aspect of the present invention includes: a storage discharge element having a substantially cuboid shape; a power collection tab lead that is thinner than the storage discharge element and is externally drawn from the storage discharge element; and an exterior film that packages the storage discharge element in a state where the power collection tab lead is externally drawn, wherein the exterior film includes: a holding part that sandwiches the power collection tab lead from front and rear surfaces in a thickness direction; a fold part along an outline of the holding part; and a reinforcement part that is folded from the fold part and is joined to at least the holding part, the fold part is joined to a side portion that extends in a thickness direction of the holding part, the reinforcement part is folded back in a direction of sandwiching the power collection tab lead by the fold part, and the reinforcement part includes an extension portion that extends from the fold part along a drawn direction of the power collection tab lead or a direction that crosses the drawn direction.

A second aspect is the pouch cell according to the first aspect, wherein the reinforcement part may include a second extension portion that is adhered to and closer to the storage discharge element than the holding part.

A third aspect is the pouch cell according to the first aspect or the second aspect, wherein a relief part that is separated from the power collection tab lead may be formed on the reinforcement part near a boundary between the fold part and the extension portion such that close contact of the reinforcement part to the holding part is not blocked by the power collection tab lead that is drawn from the holding part.

A fourth aspect is the pouch cell according to any of the first aspect to the third aspect, wherein the exterior film may include: a second fold part along an outline of the holding part; and a second reinforcement part that is folded from the second fold part and is joined to at least a surface of the holding part opposite to the reinforcement part, the second fold part may be joined to a side portion of the holding part that extends in a thickness direction, and the second reinforcement part may be folded in a direction of sandwiching the power collection tab lead by the second fold part.

According to the first aspect, by providing the reinforcement part, an end portion of the holding part on which the exterior film is laminated and at which the flat power collection tab lead is externally drawn can be covered by the fold part that is provided in parallel with the end portion, and a flat surface of the holding part can be covered by the extension portion. Thereby, the reinforcement part is welded to the holding part, and thereby, it is possible to improve the airtightness at the end portion of the holding part. At the same time, the extension portion is welded to the flat surface of the holding part, and thereby, it is possible to improve the strength and the stiffness of the holding part. Accordingly, it is possible to reinforce a portion of the pouch cell at which the power collection tab lead is provided. Furthermore, since the reinforcement part can be formed by simply folding the exterior film, it is possible to improve the airtightness and improve the stiffness and the strength without increasing the number of components. Here, the side portion of the holding part includes an end surface at which the power collection tab lead is drawn from the holding part, and a side surface formed of the folded exterior film so as to connect the front and rear surfaces of the holding part and extend in the thickness direction. Further, in a case where the fold part is formed on the side portion of the holding part that extends in the drawn direction of the power collection tab lead, the reinforcement part is welded by wrapping the side surface of the holding part near a portion where the thickness of the front and rear surfaces of the exterior film is enlarged in a triangular column shape from the holding part toward the storage discharge element side, and thereby, it is possible to prevent the welded portion from being peeled by an external force near the portion that forms the triangular column shape.

According to the second aspect, the reinforcement part includes the second extension portion at a portion having a triangular column shape formed to cover the vicinity of the portion where the exterior film is drawn from the storage discharge element to the outside of the power collection tab lead, that is, a portion where the holding part is close to the storage discharge element, and thereby, it is possible to cover and reinforce the exterior film of a surface that becomes a triangular column shape and has room for improvement in terms of durability.

Here, since the power collection tab lead has a thickness size smaller than that of the storage discharge element, the portion that is drawn from the storage discharge element to the outside of the power collection tab lead becomes a step, and the exterior film that covers this portion forms the triangular column shape. This portion requires reinforcement from the viewpoint of strength, and stiffness is required.

According to the third aspect, the relief part is formed, and thereby, it is possible to prevent the close contact of the reinforcement part to the holding part from being blocked by the power collection tab lead in the vicinity of the boundary between the fold part and the extension portion. Thereby, it is possible to further improve the airtightness at the end portion of the holding part at which the power collection tab lead is externally drawn.

According to the fourth aspect, the second reinforcement part is welded to the surface opposite in the thickness direction to the surface to which the reinforcement part is welded in the holding part, and thereby, it is possible to further reinforce the holding part and prevent the welded portion from being peeled by an external force at the portion having the triangular column shape at which the power collection tab lead is drawn from the power storage discharge element.

### BRIEF DESCRIPTION OF THE DRAWINGS

FIG. 1 is a perspective view showing a pouch cell according to a first embodiment of the present invention.

FIG. 2 is a development view showing an exterior film that forms the pouch cell according to the first embodiment.

FIG. 3 is an end surface view showing an end surface of a holding part in the pouch cell according to the first embodiment.

FIG. 4 is a process view showing a cover process using the exterior film in the pouch cell according to the first embodiment.

FIG. 5 is a process view showing the cover process using the exterior film in the pouch cell according to the first embodiment.

FIG. 6 is a process view showing the cover process using the exterior film in the pouch cell according to the first embodiment.

FIG. 7 is a perspective view showing a pouch cell according to a second embodiment of the present invention.

FIG. 8 is a development view showing an exterior film that forms the pouch cell according to the second embodiment.

FIG. 9 is a perspective view showing a pouch cell according to a third embodiment of the present invention.

FIG. 10 is a development view showing an exterior film that forms the pouch cell according to the third embodiment.

FIG. 11 is an end surface view showing an end surface of a holding part in the pouch cell according to the third embodiment.

FIG. 12 is an enlarged development view showing the vicinity of a fold part of an exterior film that forms a pouch cell according to a fourth embodiment of the present invention.

FIG. 13 is an end surface view showing an end surface of a holding part in the pouch cell according to the fourth embodiment.

FIG. 14 is an enlarged development view showing the vicinity of a fold part of another example of the exterior film that forms the pouch cell according to the fourth embodiment.

FIG. 15 is an enlarged development view showing the vicinity of a fold part of still another example of the exterior film that forms the pouch cell according to the fourth embodiment.

FIG. 16 is an enlarged development view showing the vicinity of a fold part of still another example of the exterior film that forms the pouch cell according to the fourth embodiment.

FIG. 17 is a perspective view showing a pouch cell according to a fifth embodiment of the present invention.

FIG. 18 is a development view showing an exterior film that forms the pouch cell according to the fifth embodiment.

FIG. 19 is a schematic view showing a triangular column part in the pouch cell according to the fifth embodiment.

FIG. 20 is an end surface view showing an end surface of a holding part in another example of the pouch cell according to the fifth embodiment.

FIG. 21 is a development view showing an exterior film that forms the pouch cell according to a sixth embodiment of the present invention.

### DESCRIPTION OF EMBODIMENTS

Hereinafter, a pouch cell according to a first embodiment of the present invention will be described with reference to the drawings. The present invention is not limited to the following embodiments and can be implemented with appropriate modifications within the scope of the present invention.

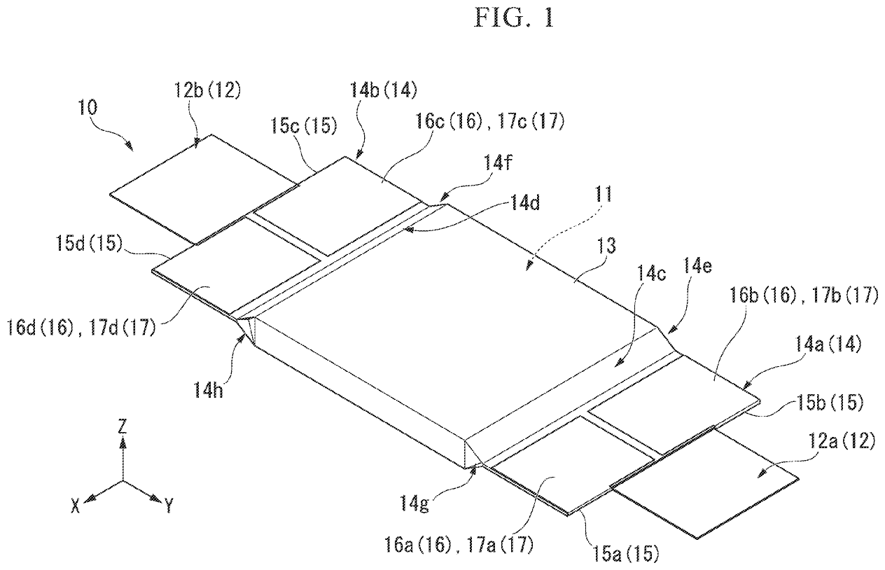

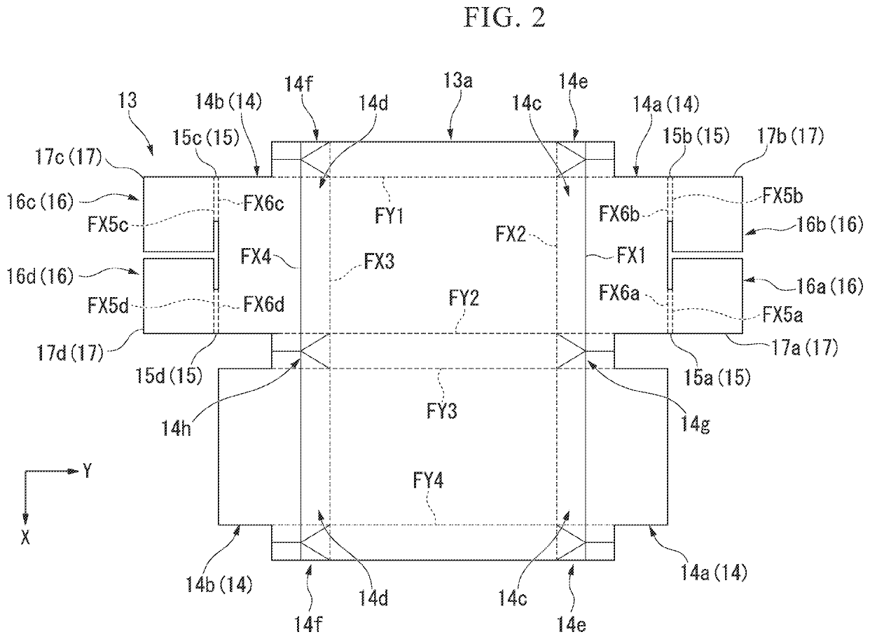

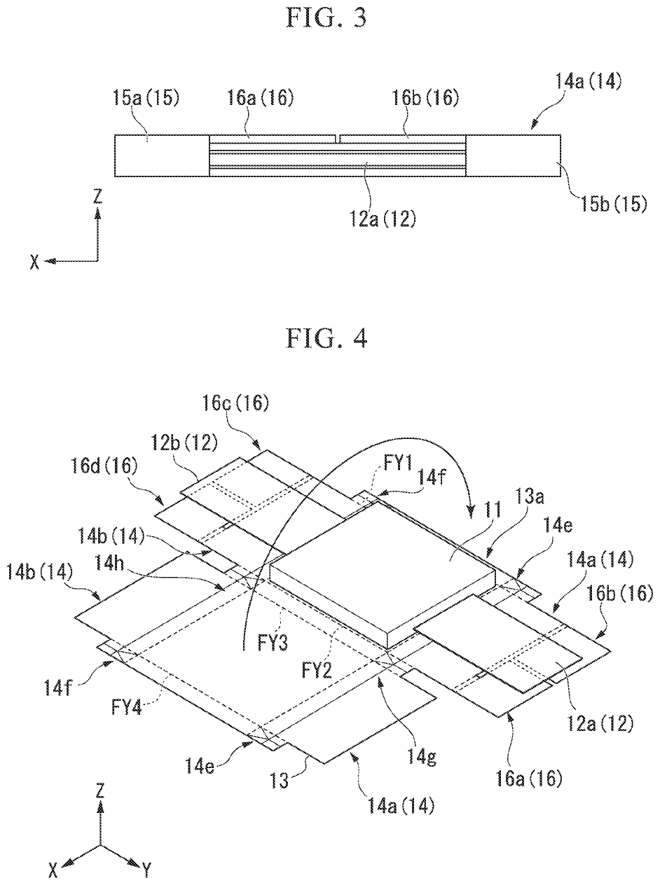

FIG. 1 is a perspective view showing a pouch cell in the present embodiment. FIG. 2 is a development view showing an exterior film of the pouch cell in the present embodiment. FIG. 3 is an end surface view showing an end portion of a holding part in the pouch cell of the present embodiment. In the drawing, reference numeral 10 represents a pouch cell.

The pouch cell 10 according to the present embodiment includes a power storage discharge element 11, a power collection tab lead 12, an exterior film 13, a holding part 14, a fold part 15, and a reinforcement part 16 as shown in FIG. 1.

The pouch cell 10 is a battery cell. The battery may be a liquid-system battery cell that uses an organic electrolysis solution as an electrolyte, may be a battery cell that includes a gel-like electrolyte, or may be a solid-state battery cell that includes a flame retardant solid electrolyte as an electrolyte instead of the electrolyte of the organic electrolysis solution. Hereinafter, the following embodiment is described using an example of a solid-state battery cell that includes a solid electrolyte as the battery cell.

The storage discharge element 11 is a laminate body in which a positive electrode layer and a negative electrode layer are laminated and a solid electrolyte layer is arranged between the positive electrode layer and the negative electrode layer. The term “laminate” means that enumerated layers are laminated and can include not only a lamination in which these layers are directly laminated but also an indirect lamination. For example, there may be another layer or the like between the positive electrode layer and the solid electrolyte layer.

The storage discharge element 11 is covered by the exterior film 13.

The storage discharge element 11 has a substantially cuboid shape. As shown in FIG. 1, the storage discharge element 11 has a plate shape in which a thickness size in a Z-direction is smaller than that in an X-direction and a Y-direction. In the storage discharge element 11, in the Z-direction view, the Y-direction is a longer direction, and the X-direction is a shorter direction. The X-direction, the Y-direction, and the Z-direction are indicated for convenience.

In the storage discharge element 11, a plurality of power collection body tabs extend from an end part in the Y-direction end, and the power collection tab lead 12 that is connected to the power collection body tab is further drawn in the Y-direction.

Two power collection tab leads 12 which are a power collection tab lead 12a and a power collection tab lead 12b are each drawn from end parts in the Y-direction of the power storage discharge element 11.

The power collection tab lead 12a is drawn from an end part which is on the right side in FIG. 1 in the Y-direction of the storage discharge element 11. The power collection tab lead 12b is drawn from an end part which is on the left side in FIG. 1 in the Y-direction of the storage discharge element 11.

The power collection tab lead 12a and the power collection tab lead 12b are drawn from the power storage discharge element 11 in a direction opposite to each other along the Y-direction. The power collection tab lead 12a and the power collection tab lead 12b extend in the Y-direction. The power collection tab lead 12a and the power collection tab lead 12b are connected to the storage discharge element 11. The end parts of the power collection tab lead 12a and the power collection tab lead 12b on the opposite side of the storage discharge element 11 side are exposed from the exterior film 13. Both the power collection tab lead 12a and the power collection tab lead 12b have a small thickness size in the Z-direction and are formed in a flat plate shape in the XY-direction. Both the power collection tab lead 12a and the power collection tab lead 12b are connected to the vicinity of a middle of the storage discharge element 11 in the X-direction.

Both the power collection tab lead 12a and the power collection tab lead 12b have a smaller thickness size in the Z-direction than the thickness size in the Z-direction of the storage discharge element 11. Both the power collection tab lead 12a and the power collection tab lead 12b have a smaller size in the X-direction than the size in the X-direction of the storage discharge element 11.

Portions of both the power collection tab lead 12a and the power collection tab lead 12b close to the storage discharge element 11 in the Y-direction are covered by the exterior film 13.

The exterior film 13 is wound in a cylindrical shape around the storage discharge element 11 as shown in FIG. 1. Both ends in the Y-direction of the exterior film 13 extend outward to be separated from the storage discharge element 11 and hold the power collection tab lead 12a and the power collection tab lead 12b from front and rear surfaces in the Z-direction. The thickness of the exterior film 13 is reduced such that the exterior film 13 is formed in a triangular column shape from the storage discharge element 11 to the power collection tab lead 12a and the power collection tab lead 12b at a boundary between the power collection tab leads 12a and 12b and the discharge element 11 that have a different thickness from each other. In this part having a triangular column shape, a portion of the exterior film 13 that becomes a gusset at both ends in the X-direction is folded inward. The exterior film 13 seals the storage discharge element 11.

As shown in FIG. 2, the exterior film 13 is a sheet-shaped pouch film. The exterior film 13 is wound on the storage discharge element 11 around an axis line in the Y-direction and is bonded and joined to the storage discharge element 11. The exterior film 13 is in close contact with the storage discharge element 11 except for both end parts in the Y-direction.

The exterior film 13 is not particularly limited as long as the exterior film 13 is a film that can house and seal the storage discharge element 11. The exterior film 13 can be preferably a film that can provide airtightness to the pouch cell 10.

The exterior film 13 may include a barrier layer formed of an inorganic thin film or the like such as a metal foil which is, for example, aluminum, nickel, stainless steel, or the like. By including the barrier layer, the exterior film 13 can be provided with airtightness. The exterior film 13 can preferably include a seal layer formed of a flexible resin, such as polyethylene resin. The exterior film 13 can be joined by welding laminated seal layers facing each other. Therefore, a process of applying an adhesive agent is not required.

The exterior film 13 may or may not include the seal layer. In this case, the exterior film 13 is joined together by an adhesive agent, and thereby, it is also possible to form the pouch cell 10.

Examples of the exterior film 13 include a laminate body in which the seal layer described above, the barrier layer described above, and a base material layer constituted of polyethylene terephthalate, polyethylene naphthalate, nylon, polypropylene, and the like are laminated. These layers may be laminated via a conventional adhesive agent or may be laminated by an extrusion coating method or the like.

A preferred thickness of the exterior film 13 varies depending on the material. The thickness of the exterior film 13 can be preferably equal to or more than 50 μm and can be more preferably equal to or more than 100 μm. The thickness of the exterior film 13 can be preferably equal to or less than 700 μm and can be more preferably equal to or less than 200 μm.

The exterior film 13 may be a single layer film or may be a film in which a plurality of layers are laminated. The exterior film 13 in the present embodiment can be a single sheet-shaped film that houses and seals the storage discharge element 11.

The exterior film 13 is welded to front and rear surfaces in the Z-direction of the power collection tab lead 12a and the power collection tab lead 12b at a position away from the storage discharge element 11 in the Y-direction and at an outside in the Y-direction of the storage discharge element 11. The exterior film 13 forms the holding part 14 at the outside in the Y-direction of the storage discharge element 11.

As shown in FIG. 1, the holding part 14 includes a holding part 14a that sandwiches the power collection tab lead 12a and a holding part 14b that sandwiches the power collection tab lead 12b.

Both the holding part 14a and the holding part 14b extend in the Y-direction. The holding part 14a and the holding part 14b extend symmetrically from the center of the storage discharge element 11 in the Y-direction. The X-direction sizes of the holding part 14a and the holding part 14b are substantially the same as the X-direction size of the storage discharge element 11.

The power collection tab lead 12a and the power collection tab lead 12b are exposed from end portions that are the outsides in the Y-direction of the holding part 14a and the holding part 14b, respectively.

The power collection tab lead 12a and the power collection tab lead 12b are located at center portions in the X-direction of the holding part 14a and the holding part 14b, respectively. The exterior film 13 is directly bonded together at both end portions in the X-direction of the holding part 14a and the holding part 14b.

The holding part 14a and the holding part 14b have an outline having a substantially rectangular shape in a Z-direction view.

The reinforcement part 16 is welded to Z-direction surfaces of the holding part 14a and the holding part 14b.

The fold part 15 is formed on the exterior film 13 on Z-direction rear surfaces of the holding part 14a and the holding part 14b.

As shown in FIG. 1 and FIG. 2, the exterior film 13 is continuous such that a side closer to the storage discharge element 11 in the Y-direction than the holding part 14a and the holding part 14b becomes large to a Z-direction thickness size of the storage discharge element 11. In the exterior film 13, the side closer to the storage discharge element 11 in the Y-direction than the holding part 14a and the holding part 14b forms a triangular column part 14c and a triangular column part 14d in accordance with an increase of the thickness size from the holding part 14a and the holding part 14b to the storage discharge element 11.

As shown in FIG. 1 and FIG. 2, in the triangular column part 14c and the triangular column part 14d, both end portions in the X-direction are folded inward and form gusset portions 14e to 14h. As shown in FIG. 2, the exterior film 13 that forms the gusset portions 14e to 14h extends to the Y-direction outside in a direction that is separated from the storage discharge element 11 while being folded in the Z-direction and extends to the middle of the holding part 14a and the holding part 14b. The Y-direction end portions of the exterior film 13 that form the gusset portions 14e to 14h are sandwiched by the holding part 14a and the holding part 14b.

As shown in FIG. 1 to FIG. 3, the fold part 15 includes a fold part 15a and a fold part 15b that are welded to a section of the Y-direction end portion of the holding part 14a. The fold part 15 includes a fold part 15c and a fold part 15d that are welded to a section of the Y-direction end portion of the holding part 14b.

The fold part 15a and the fold part 15b are formed along an outline of the Y-direction end portion of the holding part 14a. The fold part 15a and the fold part 15b have a size in the Z-direction which is substantially the same as the Z-direction size in the Y-direction end portion of the holding part 14a. The fold part 15a and the fold part 15b extend from an upper end in the Z-direction to a lower end in the Z-direction in the Y-direction end portion of the holding part 14a.

The fold part 15a and the fold part 15b are located at a further outer position in the X-direction than the power collection tab lead 12a in the Y-direction end portion of the holding part 14a.

As shown in FIG. 1 to FIG. 3, the fold part 15a covers the Y-direction end portion of the holding part 14a from the power collection tab lead 12a to the X-direction front side. As shown in FIG. 1, the fold part 15b covers the Y-direction end portion of the holding part 14a from the power collection tab lead 12a to the X-direction rear side.

The fold part 15a and the fold part 15b have a substantially rectangular outline in the Y-direction view. The fold part 15a has an outline shape and an area that are substantially equal to those of the fold part 15b.

The fold part 15c and the fold part 15d are formed along an outline of the Y-direction end portion of the holding part 14b. The fold part 15c and the fold part 15d have a size in the Z-direction which is substantially the same as the Z-direction size in the Y-direction end portion of the holding part 14b. The fold part 15c and the fold part 15d extend from an upper end in the Z-direction to a lower end in the Z-direction in the Y-direction end portion of the holding part 14b.

The fold part 15c and the fold part 15d are located at a further outer position in the X-direction than the power collection tab lead 12b in the Y-direction end portion of the holding part 14b.

As shown in FIG. 1, the fold part 15c covers the Y-direction end portion of the holding part 14b from the power collection tab lead 12b to the X-direction rear side. As shown in FIG. 1, the fold part 15d covers the Y-direction end portion of the holding part 14b from the power collection tab lead 12b to the X-direction front side.

The fold part 15c and the fold part 15d have a substantially rectangular outline in the Y-direction view. The fold part 15c has an outline shape and an area that are substantially equal to those of the fold part 15d.

As shown in FIG. 1 to FIG. 3, the reinforcement part 16 is welded to Z-direction surfaces of the holding part 14a and the holding part 14b. The reinforcement part 16 includes a reinforcement part 16a and a reinforcement part 16b that are welded to the Z-direction surface of the holding part 14a. The reinforcement part 16 includes a reinforcement part 16c and a reinforcement part 16d that are welded to the Z-direction surface of the holding part 14b. The reinforcement part 16 includes an extension portion 17 that extends along the Y-direction.

As shown in FIG. 1 to FIG. 3, the reinforcement part 16a is connected to the fold part 15a. The reinforcement part 16a is connected to a Z-direction surface side of the holding part 14a in the fold part 15a. The reinforcement part 16a includes an extension portion 17a that extends from the fold part 15a along the Y-direction in which the power collection tab lead 12a is drawn.

In the present embodiment, the outline shape of the extension portion 17a is substantially identical to the outline shape of the reinforcement part 16a.

The reinforcement part 16a is connected to the entire length in the X-direction of the fold part 15a and extends in the X-direction to a position that overlaps the power collection tab lead 12a in the Z-direction view. The reinforcement part 16a has a size in the Y-direction that is substantially the same as the Y-direction size of the holding part 14a.

The reinforcement part 16b is connected to the fold part 15b. The reinforcement part 16b is connected to a Z-direction surface side of the holding part 14a in the fold part 15b. The reinforcement part 16b includes an extension portion 17b that extends from the fold part 15b along the Y-direction in which the power collection tab lead 12a is drawn.

In the present embodiment, the outline shape of the extension portion 17b is substantially identical to the outline shape of the reinforcement part 16b.

The reinforcement part 16b is connected to the entire length in the X-direction of the fold part 15b and extends in the X-direction to a position that overlaps the power collection tab lead 12a in the Z-direction view. The reinforcement part 16b has a size in the Y-direction that is substantially the same as the Y-direction size of the holding part 14a.

The reinforcement part 16a and the reinforcement part 16b have an outline shape and an area that are substantially equal to each other. The reinforcement part 16a and the reinforcement part 16b are close to each other near the middle of the holding part 14a in the X-direction. The reinforcement part 16a and the reinforcement part 16b can also overlap each other near the middle of the holding part 14a in the X-direction.

The reinforcement part 16c is connected to the fold part 15c. The reinforcement part 16c is connected to a Z-direction surface side of the holding part 14b in the fold part 15c. The reinforcement part 16c includes an extension portion 17c that extends from the fold part 15c along the Y-direction in which the power collection tab lead 12b is drawn.

In the present embodiment, the outline shape of the extension portion 17c is substantially identical to the outline shape of the reinforcement part 16c.

The reinforcement part 16c is connected to the entire length in the X-direction of the fold part 15c and extends in the X-direction to a position that overlaps the power collection tab lead 12b in the Z-direction view. The reinforcement part 16c has a size in the Y-direction that is substantially the same as the Y-direction size of the holding part 14b.

The reinforcement part 16d is connected to the fold part 15d. The reinforcement part 16d is connected to a Z-direction surface side of the holding part 14b in the fold part 15d. The reinforcement part 16d includes an extension portion 17d that extends from the fold part 15d along the Y-direction in which the power collection tab lead 12b is drawn.

In the present embodiment, the outline shape of the extension portion 17d is substantially identical to the outline shape of the reinforcement part 16d.

The reinforcement part 16d is connected to the entire length in the X-direction of the fold part 15d and extends in the X-direction to a position that overlaps the power collection tab lead 12b in the Z-direction view. The reinforcement part 16d has a size in the Y-direction that is substantially the same as the Y-direction size of the holding part 14b.

The reinforcement part 16c and the reinforcement part 16d have an outline shape and an area that are substantially equal to each other. The reinforcement part 16c and the reinforcement part 16d are close to each other near the middle of the holding part 14b in the X-direction. The reinforcement part 16c and the reinforcement part 16d can also overlap each other near the middle of the holding part 14b in the X-direction.

In the pouch cell 10 of the present embodiment, the reinforcement part 16a and the reinforcement part 16b are adhered to the surface of the holding part 14a. Further, the end portion of the holding part 14a formed by laminating the exterior film 13 is covered by the fold part 15a and the fold part 15b. At the end portion of the holding part 14a, the reinforcement part 16a and the reinforcement part 16b are bent to the surface of the holding part 14a. At the end portion of the holding part 14a, the fold part 15a and the fold part 15b are connected to the rear surface in the Z-direction of the holding part 14a.

Thereby, it is possible to improve the airtightness at the end portion of the holding part 14a. At the same time, the extension portion 17a of the reinforcement part 16a and the extension portion 17b of the reinforcement part 16b are welded to the flat surface of the holding part 14a, and thereby, it is possible to improve the strength and the stiffness of the holding part 14a. Accordingly, it is possible to reinforce a portion of the pouch cell 10 at which the power collection tab lead 12a is provided.

Similarly, the reinforcement part 16c and the reinforcement part 16d are adhered to the surface of the holding part 14b. Further, the end portion of the holding part 14b formed by laminating the exterior film 13 is covered by the fold part 15c and the fold part 15d. At the end portion of the holding part 14b, the reinforcement part 16c and the reinforcement part 16d are bent to the surface of the holding part 14b. At the end portion of the holding part 14b, the fold part 15c and the fold part 15d are connected to the rear surface in the Z-direction of the holding part 14b.

Thereby, it is possible to improve the airtightness at the end portion of the holding part 14b. At the same time, the extension portion 17c of the reinforcement part 16c and the extension portion 17d of the reinforcement part 16d are welded to the flat surface of the holding part 14b, and thereby, it is possible to improve the strength and the stiffness of the holding part 14b. Accordingly, it is possible to reinforce a portion of the pouch cell 10 at which the power collection tab lead 12b is provided.

Hereinafter, a manufacturing method of the pouch cell 10 is described.

FIG. 4 to FIG. 6 are process views showing a cover process using the exterior film of the pouch cell in the present embodiment.

In the present embodiment, the storage discharge element 11 is placed on the exterior film 13 on which a fold line is formed, the exterior film 13 is folded in a cylindrical shape so as to seal the storage discharge element 11, and the pouch cell is formed.

As shown in FIG. 2, a plurality of parallel fold lines FX1 to FX6b along the X-direction and a plurality of parallel fold lines FY1 to FY4 along the Y-direction are formed on the exterior film 13. Both the fold lines FX1 to FX4 and the fold lines FY1 to FY4 are formed in a straight line. Further, an oblique fold line that is not along the X-direction and the Y-direction is formed on the gusset portion 14e, the gusset portion 14f, the gusset portion 14g, and the gusset portion 14h.

The fold line FX1 is formed at a boundary position between the holding part 14a and the triangular column part 14c. The fold line FX2 is formed at a boundary position between the triangular column part 14c and a central part 13a that encloses the storage discharge element 11. The fold line FX3 is formed at a boundary position between the central part 13a that encloses the storage discharge element 11 and the triangular column part 14d. The fold line FX4 is formed at a boundary position between the triangular column part 14d and the holding part 14b.

The fold line FX5a is formed at a boundary position between the fold part 15a and the reinforcement part 16a which is the extension portion 17a. The fold line FXSb is formed at a boundary position between the fold part 15b and the reinforcement part 16b which is the extension portion 17b. The fold line FX6a is formed at a boundary position between the fold part 15a and the holding part 14a. The fold line FX6b is formed at a boundary position between the fold part 15b and the holding part 14a.

The fold line FX5c is formed at a boundary position between the fold part 15c and the reinforcement part 16c which is the extension portion 17c. The fold line FX5d is formed at a boundary position between the fold part 15d and the reinforcement part 16d which is the extension portion 17d. The fold line FX6c is formed at a boundary position between the fold part 15c and the holding part 14b. The fold line FX6d is formed at a boundary position between the fold part 15d and the holding part 14b.

The fold line FY1 is formed at a boundary position between the holding part 14a and the gusset portion 14e close to the fold part 15b and at a boundary position between the holding part 14b and the gusset portion 14f close to the fold part 15c. The fold line FY2 is formed at a boundary position between the holding part 14a and the gusset portion 14g close to the fold part 15a and at a boundary position between the holding part 14b and the gusset portion 14h close to the fold part 15d.

The fold line FY3 is formed at a boundary position between the gusset portion 14g and the holding part 14a on the rear side to which the fold part 15 is not connected and at a boundary position between the gusset portion 14h and the holding part 14b on the rear side to which the fold part 15 is not connected. The fold line FY4 is formed at a boundary position between the overlapped bonded gusset portion 14e and the holding part 14a on the rear side to which the fold part 15 is not connected and a boundary position between the overlapped bonded gusset portion 14f and the holding part 14b on the rear side to which the fold part 15 is not connected.

The fold lines FX1 to FY4 are formed on the exterior film 13. The fold lines FX1 to FY4 are formed along the shape and the size of the power collection tab lead 12 and the storage discharge element 11 housed in the exterior film 13.

As shown in FIG. 4, the storage discharge element 11 to which the power collection tab lead 12a and the power collection tab lead 12b are connected is placed on the exterior film 13 at the central part 13a.

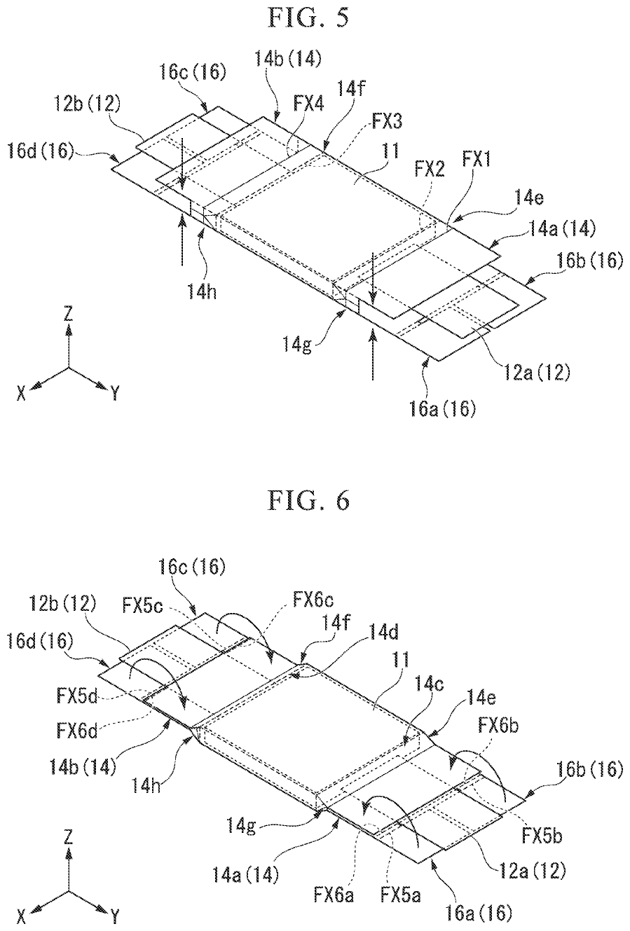

Next, all of the fold lines FY1 to FY4 that extend in the Y-direction are folded in a valley form as shown by an arrow in FIG. 4. Thereby, as shown in FIG. 5, the exterior film 13 is wound around the storage discharge element 11 so as to surround the circumference of the storage discharge element 11. Then, the gusset portion 14e, the gusset portion 14f, and a part sandwiched between the gusset portion 14e and the gusset portion 14f on the rear side in FIG. 5 are overlapped and welded. Thereby, the exterior film 13 becomes a cylindrical shape.

Next, the fold line FX2 and the fold line FX3 that extend in the X-direction are folded in a mountain form, the fold line FX1 and the fold line FX4 that extend in the X-direction are folded in a valley form, and parts that are located at a further outer side than the storage discharge element 11 in the Y-direction and become the holding part 14a and the holding part 14b are caused to be close to, overlap with, and be in contact with each other in the Z-direction as shown by an arrow in FIG. 5. At this time, all of the gusset portions 14e to 14h are folded inward in the X-direction. Then, the portions that become the holding part 14a and the holding part 14b are overlapped and welded together with the power collection tab lead 12a and the power collection tab lead 12b.

Thereby, the triangular column part 14c, the holding part 14a that extends in the Y-direction outside of the triangular column part 14c, the triangular column part 14d, and the holding part 14b that extends in the Y-direction outside of the triangular column part 14d are formed as shown in FIG. 6.

Next, the fold lines FXSa to FX6d that extend in the X-direction are folded in a valley form, and the fold parts 15a to 15d and the reinforcement parts 16a to 16d are folded as shown by an arrow in FIG. 6. The fold parts 15a to 15d are caused to come into contact with Y-direction end portions of the holding part 14a and the holding part 14b, and the reinforcement parts 16a to 16d are caused to come into contact with Z-direction surfaces of the holding part 14a and the holding part 14b. Then, the fold parts 15a to 15d are welded to the Y-direction end portions of the holding part 14a and the holding part 14b, and the reinforcement parts 16a to 16d are welded to the Z-direction surfaces of the holding part 14a and the holding part 14b. Thereby, as shown in FIG. 1, the pouch cell 10 is manufactured.

In the present embodiment, since the fold part 15a, the fold part 15b, the reinforcement part 16a, and the reinforcement part 16b can be formed by simply folding the exterior film 13, it is possible to improve the airtightness and improve the stiffness and the strength without increasing the number of components. Similarly, since the fold part 15c, the fold part 15d, the reinforcement part 16c, and the reinforcement part 16d can be formed by simply folding the exterior film 13, it is possible to improve the airtightness and improve the stiffness and the strength without increasing the number of components.

Hereinafter, a pouch cell according to a second embodiment of the present invention is described with reference to the drawings.

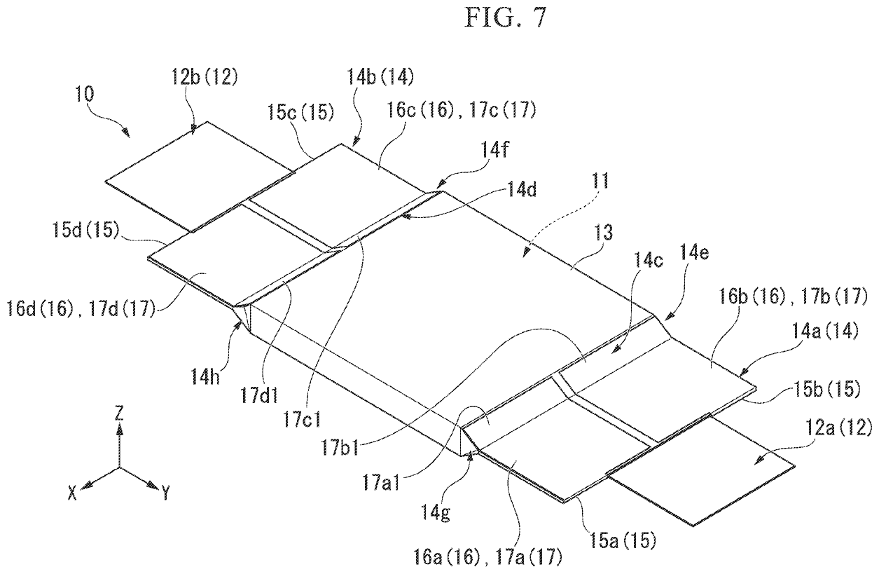

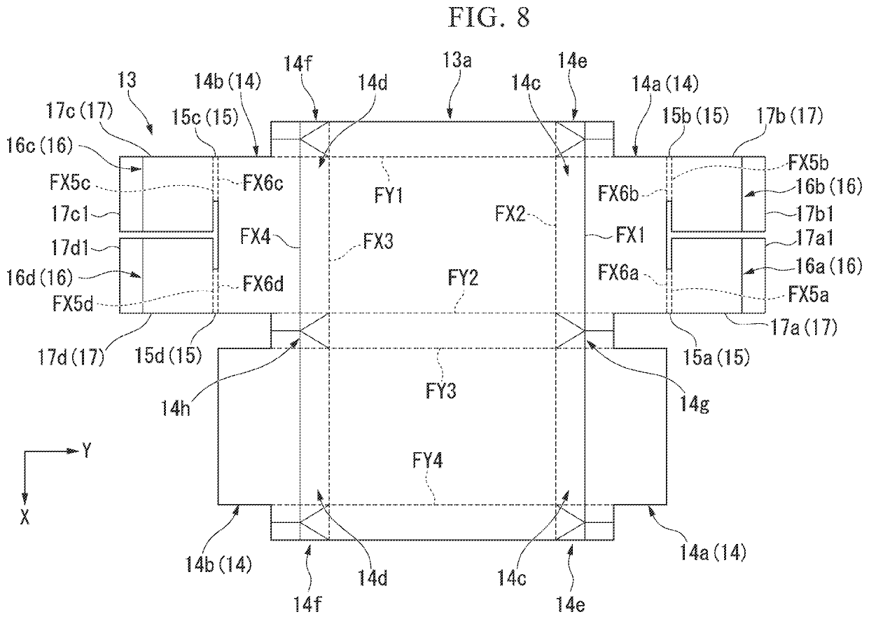

FIG. 7 is a perspective view showing a pouch cell in the present embodiment. FIG. 8 is a development view showing an exterior film of the pouch cell in the present embodiment. Although the present embodiment differs from the first embodiment described above regarding a reinforcement part, the same reference numerals are given to other configurations that correspond to the first embodiment described above, and description thereof is omitted.

In the present embodiment, as shown in FIG. 7 and FIG. 8, the reinforcement part 16a includes a second extension portion 17a1 that extends in the Y-direction further than the extension portion 17a. The second extension portion 17a1 is bonded to a Z-direction surface of the holding part 14a similarly to the extension portion 17a and is further bonded to a Z-direction surface of the triangular column part 14c adjacent to the holding part 14a. The second extension portion 17a1 has a substantially rectangular outline. The second extension portion 17a1 has an X-direction size substantially equal to the extension portion 17a.

Similarly, the reinforcement part 16b includes a second extension portion 17b1 that extends in the Y-direction further than the extension portion 17b. The second extension portion 17b1 is bonded to a Z-direction surface of the holding part 14a similarly to the extension portion 17b and is further bonded to a Z-direction surface of the triangular column part 14c adjacent to the holding part 14a. The second extension portion 17b1 has a substantially rectangular outline. The second extension portion 17b1 has an X-direction size substantially equal to the extension portion 17b.

In the present embodiment, as shown in FIG. 7 and FIG. 8, the reinforcement part 16c includes a second extension portion 17c1 that extends in the Y-direction further than the extension portion 17c. The second extension portion 17c1 is bonded to a Z-direction surface of the holding part 14b similarly to the extension portion 17c and is further bonded to a Z-direction surface of the triangular column part 14d adjacent to the holding part 14b. The second extension portion 17c1 has a substantially rectangular outline. The second extension portion 17c1 has an X-direction size substantially equal to the extension portion 17c.

Similarly, the reinforcement part 16d includes a second extension portion 17d1 that extends in the Y-direction further than the extension portion 17d. The second extension portion 17d1 is bonded to a Z-direction surface of the holding part 14b similarly to the extension portion 17d and is further bonded to a Z-direction surface of the triangular column part 14d adjacent to the holding part 14b. The second extension portion 17d1 has a substantially rectangular outline. The second extension portion 17d1 has an X-direction size substantially equal to the extension portion 17d.

In the present embodiment, the reinforcement parts 16a to 16d include the second extension portions 17a1 to 17d1, and thereby, it is possible to cover and reinforce the boundary between the triangular column part 14c and the holding part 14a and the vicinity thereof and the boundary between the triangular column part 14d and the holding part 14b and the vicinity thereof, which have room for improvement in terms of durability.

Thereby, the triangular column parts 14c and 14d at which the power collection tab lead 12 having a small thickness size is externally drawn from the storage discharge element 11 and which form a step require reinforcement from the viewpoint of strength, and stiffness is required. However, it is possible to satisfy the requirements.

Hereinafter, a pouch cell according to a third embodiment of the present invention is described with reference to the drawings.

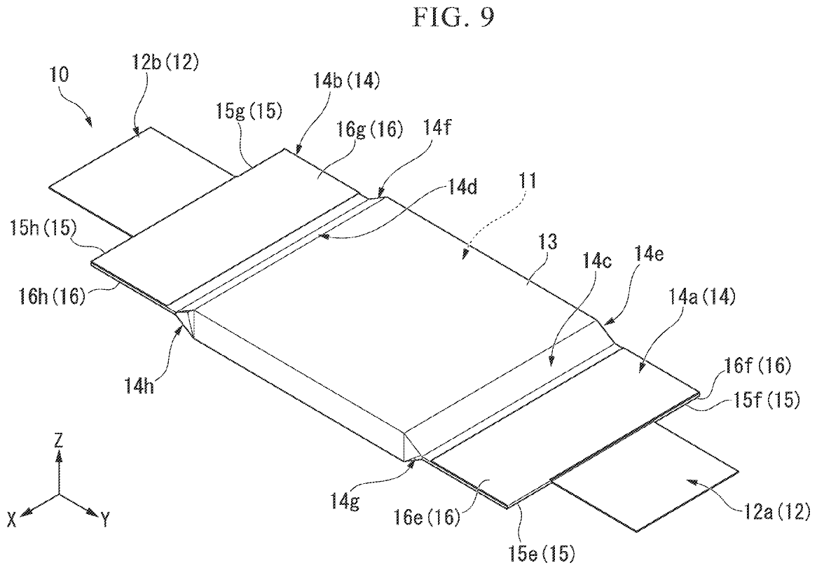

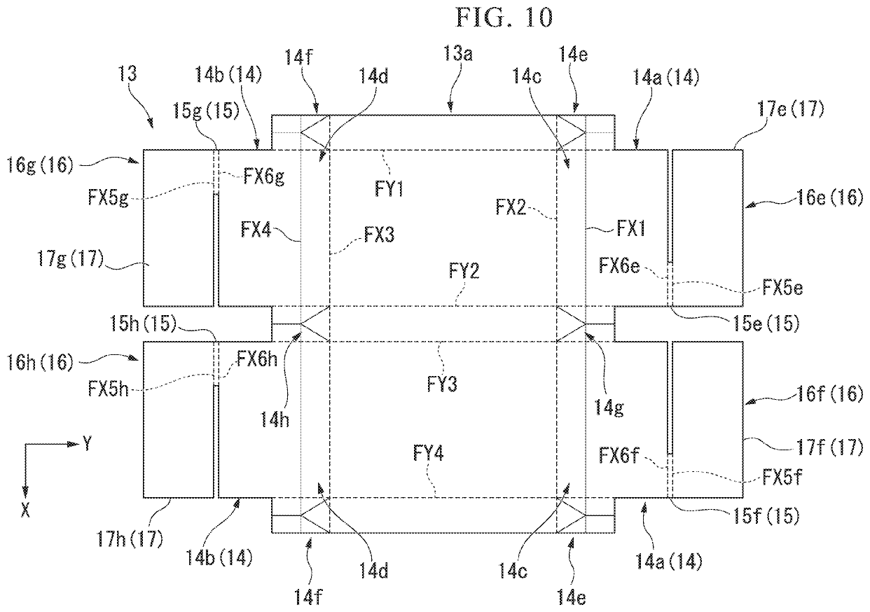

FIG. 9 is a perspective view showing a pouch cell in the present embodiment. FIG. 10 is a development view showing an exterior film of the pouch cell in the present embodiment. FIG. 11 is an end surface view showing an end portion of a holding part in the pouch cell of the present embodiment. Although the present embodiment differs from the first embodiment described above regarding a second fold part and a second reinforcement part, the same reference numerals are given to other configurations that correspond to the first embodiment described above, and description thereof is omitted.

In the present embodiment, as shown in FIG. 9 to FIG. 11, the exterior film 13 that becomes a Z-direction rear surface of the holding part 14a extends and forms a fold part 15e and a reinforcement part 16e. The fold part 15e is bonded to a Y-direction end portion of the holding part 14a as shown in FIG. 9 to FIG. 11. The reinforcement part 16e is bonded to a Z-direction front surface of the holding part 14a as shown in FIG. 9 to FIG. 11.

The exterior film 13 that becomes a Z-direction front surface of the holding part 14a extends and forms a second fold part 15f and a second reinforcement part 16f. The second fold part 15e is bonded to a Y-direction end portion of the holding part 14a as shown in FIG. 9 to FIG. 11. The second reinforcement part 16f is bonded to a Z-direction rear surface of the holding part 14a as shown in FIG. 9 to FIG. 11.

Similarly, the exterior film 13 that becomes a Z-direction rear surface of the holding part 14b extends and forms a fold part 15g and a reinforcement part 16g. The fold part 15g is bonded to a Y-direction end portion of the holding part 14b as shown in FIG. 9 to FIG. 11. The reinforcement part 16g is bonded to a Z-direction front surface of the holding part 14b as shown in FIG. 9 to FIG. 11.

The exterior film 13 that becomes a Z-direction front surface of the holding part 14b extends and forms a second fold part 15h and a second reinforcement part 16h. The second fold part 15h is bonded to a Y-direction end portion of the holding part 14b as shown in FIG. 9 to FIG. 11. The second reinforcement part 16h is bonded to a Z-direction rear surface of the holding part 14b as shown in FIG. 9 to FIG. 11.

The fold part 15e and the second fold part 15f are bonded to the Y-direction end portion of the holding part 14a at both outer positions in the X-direction of the power collection tab lead 12a as shown in FIG. 9 to FIG. 11. As shown in FIG. 10, the fold part 15e is formed on a side of the holding part 14a close to the gusset portion 14g in the X-direction. As shown in FIG. 10, the second fold part 15f is formed on a side of the holding part 14a close to the gusset portion 14e in the X-direction.

The fold part 15e is bonded to a position that corresponds to the fold part 15a shown in FIG. 3.

The second fold part 15f is bonded to a position that corresponds to the fold part 15b shown in FIG. 3.

The fold part 15g and the second fold part 15h are bonded to the Y-direction end portion of the holding part 14b at both outer positions in the X-direction of the power collection tab lead 12b as shown in FIG. 9 to FIG. 11. As shown in FIG. 10, the fold part 15g is formed on a side of the holding part 14b close to the gusset portion 14f in the X-direction. As shown in FIG. 10, the second fold part 15h is formed on a side of the holding part 14b close to the gusset portion 14h in the X-direction.

The fold part 15g is bonded to a position that corresponds to the fold part 15c shown in FIG. 3.

The second fold part 15h is bonded to a position that corresponds to the fold part 15d shown in FIG. 3.

The fold part 15e and the second fold part 15f have an outline shape substantially equal to that of the fold part 15a and the fold part 15b shown in FIG. 2. The fold part 15g and the second fold part 15h have an outline shape substantially equal to that of the fold part 15c and the fold part 15d shown in FIG. 2.

The reinforcement part 16e and the second reinforcement part 16f, unlike the reinforcement part 16a and the reinforcement part 16b shown in FIG. 2, have an outline shape substantially equal to that of the holding part 14a. That is, the reinforcement part 16e and the second reinforcement part 16f have an X-direction size substantially equal to that of the holding part 14a. The reinforcement part 16e includes an extension portion 17e that extends from the fold part 15e in the Y-direction and also extends in the X-direction. The second reinforcement part 16f includes an extension portion 17f that extends from the second fold part 15f in the Y-direction and also extends in the X-direction.

The reinforcement part 16g and the second reinforcement part 16h, unlike the reinforcement part 16c and the reinforcement part 16d shown in FIG. 2, have an outline shape substantially equal to that of the holding part 14b. That is, the reinforcement part 16g and the second reinforcement part 16h have an X-direction size substantially equal to that of the holding part 14b. The reinforcement part 16g includes an extension portion 17g that extends from the fold part 15g in the Y-direction and also extends in the X-direction. The second reinforcement part 16h includes an extension portion 17h that extends from the second fold part 15h in the Y-direction and also extends in the X-direction.

Hereinafter, a manufacturing method of the pouch cell 10 in the present embodiment is described.

Description of the same process as the cover process using the exterior film of the pouch cell in the first embodiment shown in FIG. 4 to FIG. 6 is omitted.

In the present embodiment, as shown in FIG. 10, a fold line is formed on the exterior film 13.

A fold line FX5e is formed at a boundary position between the fold part 15e and the reinforcement part 16e that has the extension portion 17e. A fold line FX5f is formed at a boundary position between the second fold part 15f and the second reinforcement part 16f that has the extension portion 17f. A fold line FX6e is formed at a boundary position between the fold part 15e and the holding part 14a which becomes a Z-direction rear surface. A fold line FX6f is formed at a boundary position between the second fold part 15f and the holding part 14a which becomes a Z-direction front surface.

A fold line FX5g is formed at a boundary position between the fold part 15g and the reinforcement part 16g that has the extension portion 17g. A fold line FX5h is formed at a boundary position between the second fold part 15h and the second reinforcement part 16h that has the extension portion 17h. A fold line FX6g is formed at a boundary position between the fold part 15g and the holding part 14b which becomes a Z-direction rear surface. A fold line FX6h is formed at a boundary position between the second fold part 15h and the holding part 14b which becomes a Z-direction front surface.

In the present embodiment, the exterior film 13 on which the storage discharge element 11 is placed is formed in a cylindrical shape, and the holding part 14a and the holding part 14b are formed.

Next, the fold lines FX5e to FX6h that extend in the X-direction are folded in a valley form, and the fold part 15e to the second fold part 15h and the reinforcement part 16e to the second reinforcement part 16h are folded similarly to FIG. 6. The fold part 15e to the second fold part 15h are caused to come into contact with Y-direction end portions of the holding part 14a and the holding part 14b.

The reinforcement part 16e is caused to come into contact with a Z-direction front surface of the holding part 14a. The reinforcement part 16g is caused to come into contact with a Z-direction front surface of the holding part 14b. The second reinforcement part 16f is caused to come into contact with a Z-direction rear surface of the holding part 14a. The second reinforcement part 16h is caused to come into contact with a Z-direction rear surface of the holding part 14b.

Then, the fold part 15e to the second fold part 15h are welded to the Y-direction end portions of the holding part 14a and the holding part 14b, the reinforcement part 16e is welded to the Z-direction front surface of the holding part 14a, the reinforcement part 16g is welded to the Z-direction front surface of the holding part 14b, the second reinforcement part 16f is welded to the Z-direction rear surface of the holding part 14a, and the second reinforcement part 16h is welded to the Z-direction rear surface of the holding part 14b. Thereby, as shown in FIG. 9, the pouch cell 10 is manufactured.

Even in the present embodiment, an advantage similar to that of the first embodiment described above can be achieved.

Specifically, substantially the entire surface of all of the holding part 14 is formed of the exterior film 13 in which four layers are laminated in the thickness direction, and it becomes possible to improve the strength and the stiffness. Accordingly, it is possible to further reinforce a portion of the pouch cell 10 at which the power collection tab lead 12 is provided. Furthermore, since each of the fold part 15e, the reinforcement part 16e, the second fold part 15f, and the second reinforcement part 16f can be formed by simply folding the exterior film 13, and similarly, each of the fold part 15g, the reinforcement part 16g, the second fold part 15h, and the second reinforcement part 16h can be formed by simply folding the exterior film 13, it is possible to improve the airtightness and improve the stiffness and the strength without increasing the number of components.

Hereinafter, a pouch cell according to a fourth embodiment of the present invention is described with reference to the drawings.

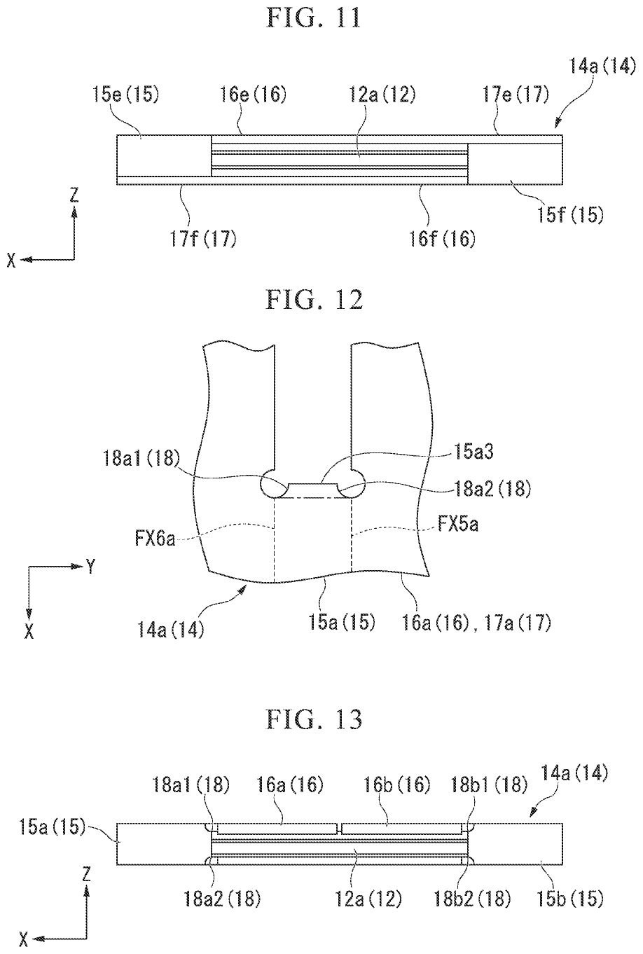

FIG. 12 is an enlarged development view showing the vicinity of a fold part of an exterior film of a pouch cell in the present embodiment. FIG. 13 is an end surface view showing an end portion of a holding part in the pouch cell in the present embodiment. Although the present embodiment differs from the first to third embodiments described above regarding a relief part which is an outline of the exterior film in the vicinity of the fold part, the same reference numerals are given to other configurations that correspond to the first to third embodiments described above, and description thereof is omitted.

In the present embodiment, a relief part 18 is formed on a reinforcement part 16 in the vicinity of a boundary between a fold part 15 and an extension portion 17.

As shown in FIG. 12 and FIG. 13, the relief part 18 is formed on an X-direction inside of the fold part 15, namely near a corner portion of a slit formed of a holding part 14, the fold part 15, and the reinforcement part 16 in the development view of the exterior film 13.

As shown in FIG. 12 and FIG. 13, the relief part 18 includes a relief part 18a1 which is an enlarged corner portion formed of a Y-direction end portion of the holding part 14a and an X-direction inner end portion of a fold part 15a in the development view of the exterior film 13. The relief part 18 includes a relief part 18a2 which is an enlarged corner portion formed of an X-direction inner end portion of the fold part 15a and an end portion of a reinforcement part 16a adjacent to a fold part 15a in the development view of the exterior film 13.

The outline of the relief part 18a1 is formed in an arc shape. The arc that forms the relief part 18a1 is centered on an intersection point between the Y-direction end portion of the holding part 14a and the X-direction inner end portion of the fold part 15a in the development view of the exterior film 13.

The outline of the relief part 18a2 is formed in an arc shape. The arc that forms the relief part 18a2 is centered on an intersection point between the X-direction inner end portion of the fold part 15a and the end portion of the reinforcement part 16a adjacent to the fold part 15a in the development view of the exterior film 13.

Further, as shown in FIG. 12 and FIG. 13, the relief part 18 includes a relief part 18b1 which is an enlarged corner portion formed of a Y-direction end portion of the holding part 14a and an X-direction inner end portion of a fold part 15b in the development view of the exterior film 13. The relief part 18 includes a relief part 18b2 which is an enlarged corner portion formed of an X-direction inner end portion of the fold part 15a and an end portion of a reinforcement part 16b adjacent to a fold part 15b in the development view of the exterior film 13.

The outline of the relief part 18b1 is formed in an arc shape. The arc that forms the relief part 18b1 is centered on an intersection point between the Y-direction end portion of the holding part 14a and the X-direction inner end portion of the fold part 15b in the development view of the exterior film 13.

The outline of the relief part 18b2 is formed in an arc shape. The arc that forms the relief part 18b2 is centered on an intersection point between the X-direction inner end portion of the fold part 15b and the end portion of the reinforcement part 16b adjacent to the fold part 15b in the development view of the exterior film 13.

In FIG. 13, the relief part 18 is schematically shown.

The relief part 18a1 and the relief part 18a2 can be formed in a shape symmetrical to each other in the Y-direction. The relief part 18b1 and the relief part 18b2 can also be formed in a shape symmetrical to each other in the Y-direction. Further, the relief part 18a1 and the relief part 18b1 can be formed in a shape symmetrical to each other in the X-direction. The relief part 18a2 and the relief part 18b2 can be formed in a shape symmetrical to each other in the X-direction.

Similarly, the relief part 18 is also formed on a fold part 15c and a fold part 15d.

By forming the relief part 18a1, the corner portion of the slit in the development view of the exterior film 13 is separated from a corner portion of a power collection tab lead 12a. By forming the relief part 18a2, the corner portion of the slit in the development view of the exterior film 13 is separated from a corner portion of the power collection tab lead 12a.

By forming the relief part 18a1 and the relief part 18a2, a protrusion portion 15a3 is formed on an X-direction inner end portion of the fold part 15a.

By forming the relief part 18b1, the corner portion of the slit in the development view of the exterior film 13 is separated from a corner portion of the power collection tab lead 12a. By forming the relief part 18b2, the corner portion of the slit in the development view of the exterior film 13 is separated from a corner portion of the power collection tab lead 12a.

By forming the relief part 18b1 and the relief part 18b2, similarly to the protrusion portion 15a3, a protrusion portion 15b3 is formed on an X-direction inner end portion of the fold part 15a.

Thereby, when the exterior film 13 is caused to come into close contact with the vicinity of the Y-direction end portion of the holding part 14a, the exterior film 13 can be separated from the power collection tab lead 12a such that the close contact of the fold part 15a, the reinforcement part 16a, the fold part 15b, and the reinforcement part 16b to the holding part 14a is not blocked by the power collection tab lead 12a drawn from the Y-direction end portion of the holding part 14a. Thereby, even when the protrusion portion 15b3 is not in close contact with the Y-direction end portion of the holding part 14a, it is possible to maintain the close contact property in other parts.

Similarly, by forming the relief part 18 also on the fold part 15c and the fold part 15d, the exterior film 13 can be separated from the power collection tab lead 12b when the exterior film 13 is caused to come into close contact with the vicinity of the Y-direction end portion of the holding part 14b.

Thereby, it is possible to prevent the close contact of the reinforcement part 16 to the holding part 14 from being blocked by the power collection tab lead 12 in the vicinity of the boundary between the fold part 15 and the extension portion 17. It is possible to further improve the airtightness at the Y-direction end portion of the holding part 14 at which the power collection tab lead 12 is externally drawn.

Even in the present embodiment, an advantage similar to those of the embodiments described above can be achieved.

In the present embodiment, the outline of the relief part 18 is formed in an arc-shape; however, the embodiment is not limited to this configuration.

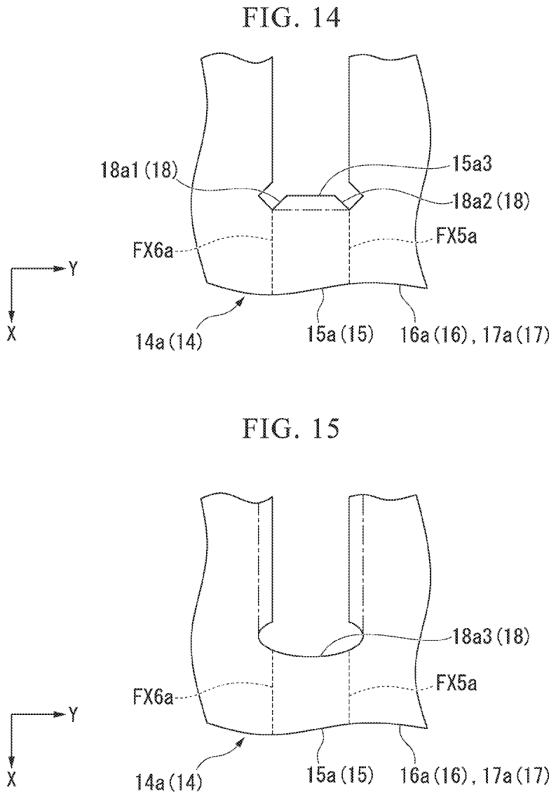

For example, as shown in FIG. 14, the outline of the relief part 18 can also be a rectangular shape. Alternatively, as shown in FIG. 15, the relief part 18a1 and the relief part 18a2 can also be in a continuous elliptical shape. In this case, a protrusion portion is not formed.

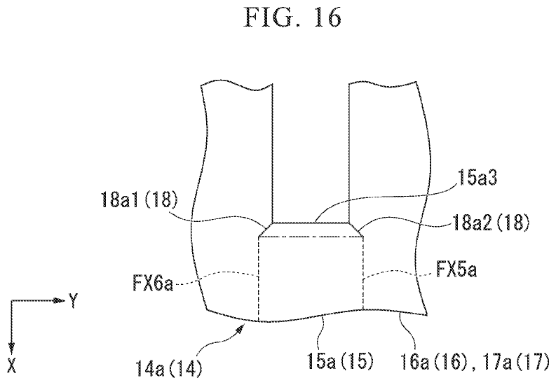

Further, as shown in FIG. 16, a relief part 18 having a linear shape can also be formed.

Hereinafter, a pouch cell according to a fifth embodiment of the present invention is described with reference to the drawings.

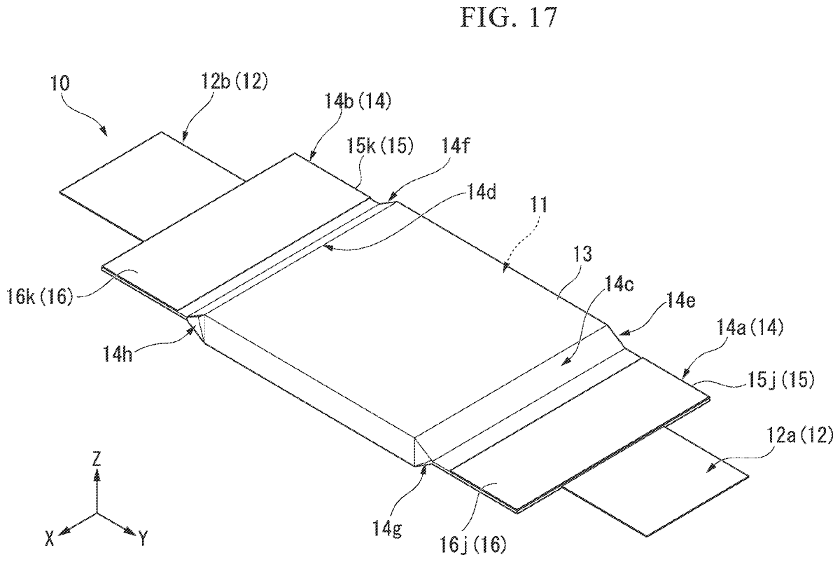

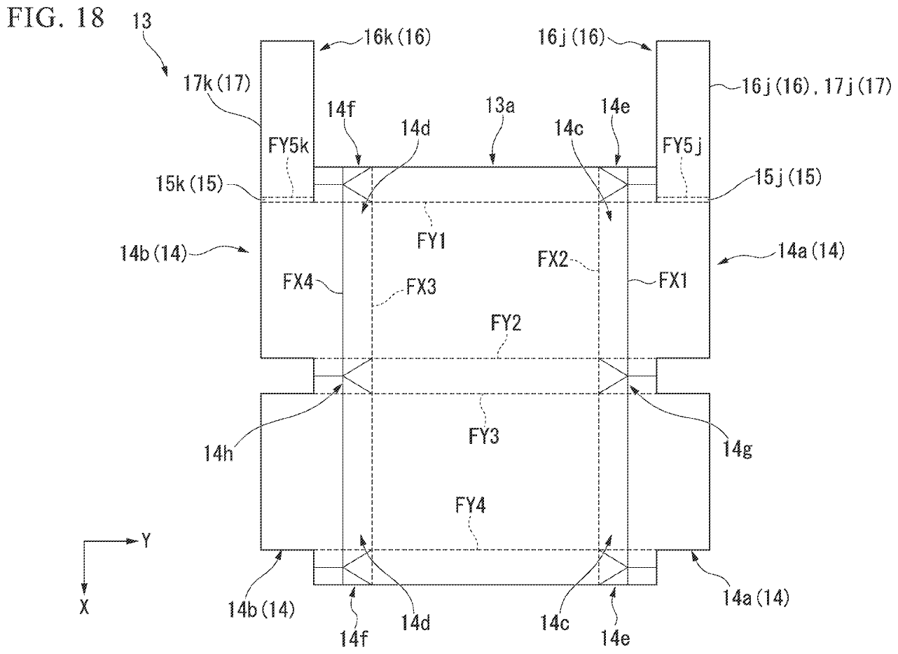

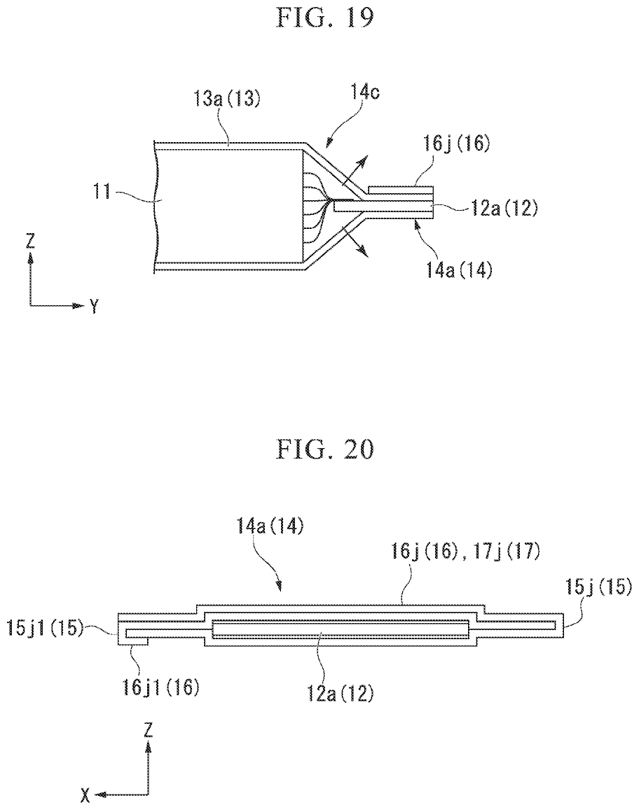

FIG. 17 is a perspective view showing a pouch cell in the present embodiment. FIG. 18 is a development view showing an exterior film of the pouch cell in the present embodiment. FIG. 19 is a schematic view showing a triangular column part in the pouch cell of the present embodiment. Although the present embodiment differs from the first to fourth embodiments described point regarding a fold part and a reinforcement part, the same reference numerals are given to other configurations that correspond to the first to fourth embodiments described above, and description thereof is omitted.

In the present embodiment, as shown in FIG. 17 and FIG. 18, a fold part 15j and a reinforcement part 16j are formed by extending the exterior film 13 that becomes a Z-direction rear surface of the holding part 14a in the X-direction. The fold part 15j is bonded to an X-direction end portion of the holding part 14a as shown in FIG. 17 and FIG. 18. The reinforcement part 16j is bonded to a Z-direction front surface of the holding part 14a as shown in FIG. 17 and FIG. 18.

Similarly, a fold part 15k and a reinforcement part 16k are formed by extending the exterior film 13 that becomes a Z-direction rear surface of the holding part 14b in the X-direction. The fold part 15k is bonded to a Y-direction end portion of the holding part 14b as shown in FIG. 17 and FIG. 18. The reinforcement part 16k is bonded to a Z-direction front surface of the holding part 14b as shown in FIG. 17 and FIG. 18.

The fold part 15j and the fold part 15k are bonded to one outer position in the X-direction of the power collection tab lead 12a at a Y-direction end portion of the holding part 14a as shown in FIG. 17 and FIG. 18. As shown in FIG. 18, the fold part 15j is formed on a side of the holding part 14a close to a gusset portion 14e in the X-direction.

As shown in FIG. 18, the fold part 15k is formed on a side of the holding part 14a close to a gusset portion 14f in the X-direction.

Even in the present embodiment, as shown in FIG. 18, a fold line is formed on the exterior film 13.

A fold line FY1 extends to both outer sides in the Y-direction compared to the configuration of the above-described embodiments shown in FIG. 2, FIG. 8, and FIG. 10. The fold line FY1 forms an X-direction end portion in the holding part 14a and the holding part 14b. Both end portions in the Y-direction in the fold line FY1 are formed at a boundary position between the holding part 14a and the fold part 15j and at a boundary position between the holding part 14b and the fold part 15k.

The fold line FY5j is formed at a boundary position between the fold part 15j and the reinforcement part 16j having an extension portion 17j. The fold line FY5j extends in the Y-direction and is formed in parallel with the fold line FY1.

The fold line FY5k is formed at a boundary position between the fold part 15k and the reinforcement part 16k having an extension portion 17k. The fold line FY5k extends in the Y-direction and is formed in parallel with the fold line FY1.

Even in the present embodiment, the exterior film 13 on which the storage discharge element 11 is placed is formed in a cylindrical shape, and the holding part 14a and the holding part 14b are formed.

Next, the fold lines FY1 to FY5k that extend in the Y-direction are folded in a valley form, and similarly to FIG. 6, the fold part 15j, the fold part 15k, the reinforcement part 16j, and the reinforcement part 16k are folded.

The reinforcement part 16j is caused to come into contact with a Z-direction surface of the holding part 14a. The reinforcement part 16k is caused to come into contact with a Z-direction surface of the holding part 14b.

Then, the fold part 15j and the fold part 15k are welded to the X-direction end portions of the holding part 14a and the holding part 14b, the reinforcement part 16j is welded to the Z-direction surface of the holding part 14a, and the reinforcement part 16k is welded to the Z-direction surface of the holding part 14b. Thereby, the pouch cell 10 is manufactured as shown in FIG. 17.

In the present embodiment, the fold part 15j, the reinforcement part 16j, the fold part 15k, and the reinforcement part 16k are wound around and cover the holding part 14a and the holding part 14b from the end portion in the X-direction.

That is, the fold part 15 is formed at a position that becomes a side portion of the holding part 14 with respect to a drawn direction of the power collection tab lead 12. Thereby, the reinforcement part 16j is welded by wrapping, from a side surface in the X-direction, the holding part 14a near a portion where the thickness is enlarged from the holding part 14a to the triangular column part 14c. Similarly, the reinforcement part 16k is welded by wrapping, from a side surface in the X-direction, the holding part 14b near a portion where the thickness is enlarged from the holding part 14b to the triangular column part 14d.

Here, when the holding part 14 is pulled in a Y-direction outward direction, an external force that separates Z-direction front and rear surfaces of the triangular column parts 14c and 14d from each other acts on the vicinity of the triangular column parts 14c and 14d as shown by arrows in FIG. 19. There is a possibility that the welded portion of the holding part 14 may be peeled by the external force; however, in the present embodiment, it is possible to prevent this.

Even in the present embodiment, an advantage similar to those of the embodiments described above can be achieved.

In the embodiment, the fold part 15j and the fold part 15k are connected to one end portion in the X-direction of the holding part 14a and the holding part 14b; however, the present embodiment is not limited to this configuration.

FIG. 20 is an end surface view showing an end portion of a holding part in another example of the pouch cell in the present embodiment.

For example, as shown in FIG. 20, a second fold part 15j1 can be formed on the opposite side of the fold part 15j in the X-direction in the holding part 14a, and a second reinforcement part 16j1 can be welded to a Z-direction rear surface in the holding part 14a. In this case, the second reinforcement part 16j1 can be an X-direction length that does not affect the exterior film 13 which becomes a surface of the holding part 14a as shown in FIG. 18.

Thereby, the reinforcement part 16 can be wound on both X-direction end portions of the holding part 14a, and it is possible to further prevent peeling of the triangular column part 14c. The holding part 14b can also have a similar configuration.

Alternatively, in the configuration shown in FIG. 18, the X-direction length of the reinforcement part 16j can be larger than the X-direction length of the holding part 14a, the reinforcement part 16j can be welded to a Z-direction front surface of the holding part 14a, and the remaining reinforcement part 16j can be welded to a Z-direction rear surface of the holding part 14a. In this case, the reinforcement part 16 can also be wound on both X-direction end portions of the holding part 14a.

Hereinafter, a pouch cell according to a sixth embodiment of the present invention is described with reference to the drawings.

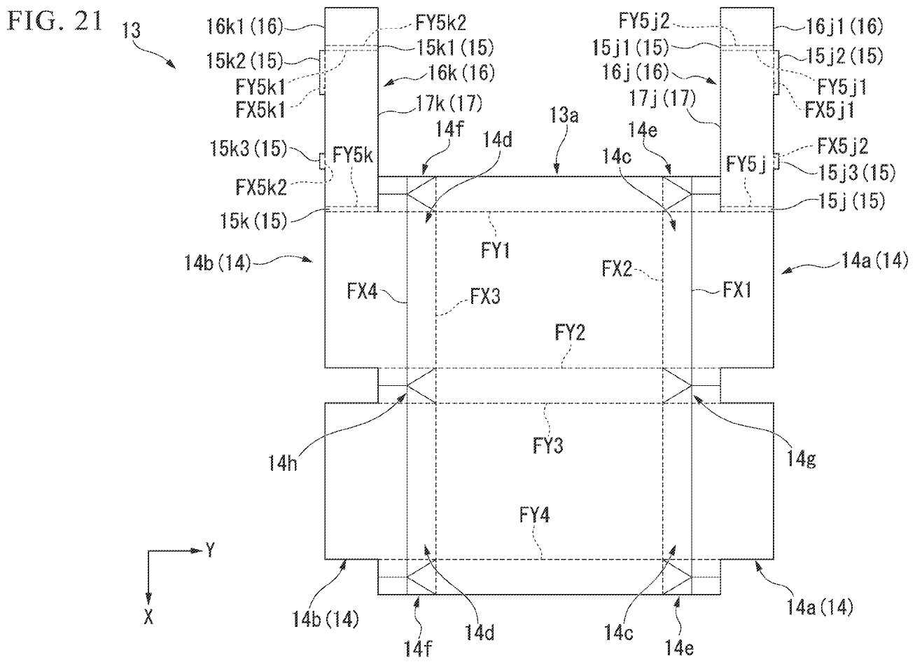

FIG. 21 is a development view showing an exterior film of a pouch cell in the present embodiment. Although the present embodiment differs from the first to fifth embodiments described above regarding a fold part and a reinforcement part, the same reference numerals are given to other configurations that correspond to the first to fifth embodiments described above, and description thereof is omitted.

In the present embodiment, as shown in FIG. 21, in addition to another example of the fifth embodiment, fold parts 15j2, 15j3, 15k2, and 15k3 are provided.

The fold parts 15j2, 15j3, 15k2, and 15k3 are welded to Y-direction end portions of the holding part 14a and the holding part 14b.

The fold part 15j2 is welded to a position corresponding to the fold part 15b. The fold part 15k2 is welded to a position corresponding to the fold part 15c. The fold part 15j2 has an outline shape that is substantially equal to the fold part 15b. The fold part 15k2 has an outline shape that is substantially equal to the fold part 15c.

The fold part 15j3 is welded to a position corresponding to a portion of the fold part 15a. The fold part 15j3 is welded to a position that becomes a side of the fold part 15a close to the power collection tab lead 12a. The X-direction length of the fold part 15j3 is set to be smaller by the X-direction length of the second reinforcement part 16j1 than the X-direction length of the fold part 15a.

The fold part 15k3 is welded to a position corresponding to a portion of the fold part 15b. The fold part 15k3 is welded to a position that becomes a side of the fold part 15b close to the power collection tab lead 12b. The X-direction length of the fold part 15k3 is set to be smaller by the X-direction length of a second reinforcement part 16k1 than the X-direction length of the fold part 15b.

Even in the present embodiment, as shown in FIG. 21, a fold line is formed on the exterior film 13.

A fold line FY5j1 is formed at a boundary position between the reinforcement part 16j and the second fold part 15j1. The fold line FY5j1 extends in the Y-direction and is formed in parallel with the fold line FY5j. A fold line FY5j2 is formed at a boundary position between the second fold part 15j1 and the second reinforcement part 16j1. The fold line FY5j2 extends in the Y-direction and is formed in parallel with the fold line FY5j.

A fold line FY5k1 is formed at a boundary position between the reinforcement part 16k and the second fold part 15k1. The fold line FY5k1 extends in the Y-direction and is formed in parallel with the fold line FY5k. A fold line FY5k2 is formed at a boundary position between the second fold part 15k1 and the second reinforcement part 16k1. The fold line FY5k2 extends in the Y-direction and is formed in parallel with the fold line FY5k.

A fold line FX5j1 is formed at a boundary position between the reinforcement part 16j and the fold part 15j2. The fold line FX5j1 extends in the X-direction and is formed in parallel with the fold line FX1.

A fold line FX5j2 is formed at a boundary position between the reinforcement part 16j and the fold part 15j3. The fold line FX5j2 extends in the X-direction and is formed in parallel with the fold line FX1.

A fold line FX5k1 is formed at a boundary position between the reinforcement part 16k and the fold part 15k2. The fold line FX5k1 extends in the X-direction and is formed in parallel with the fold line FX1.

A fold line FX5k2 is formed at a boundary position between the reinforcement part 16k and the fold part 15k3. The fold line FX5k2 extends in the X-direction and is formed in parallel with the fold line FX1.

Even in the present embodiment, the exterior film 13 on which the storage discharge element 11 is placed is formed in a cylindrical shape, and the holding part 14a and the holding part 14b are formed.

Next, the fold lines FY1 to FY5k that extend in the Y-direction are folded in a valley form, and similarly to FIG. 6, the fold part 15j, the fold part 15k, the reinforcement part 16j, and the reinforcement part 16k are folded.

The reinforcement part 16j is caused to come into contact with a Z-direction front surface of the holding part 14a. The reinforcement part 16k is caused to come into contact with a Z-direction front surface of the holding part 14b.

Further, the fold lines FY5j1 to FY5k2 that extend in the Y-direction are folded in a valley form, and the second fold part 15j1, the second fold part 15k1, the second reinforcement part 16j1, and the second reinforcement part 16k1 are folded. The second reinforcement part 16j1 is caused to come into contact with a Z-direction rear surface of the holding part 14a. The second reinforcement part 16k1 is caused to come into contact with a Z-direction rear surface of the holding part 14b.

Then, the fold part 15j, the fold part 15k, the second fold part 15j1, and the second fold part 15k1 are welded to X-direction end portions of the holding part 14a and the holding part 14b, the reinforcement part 16j and the reinforcement part 16k are welded to the Z-direction front surfaces of the holding part 14a and the holding part 14b, and the second reinforcement part 16j1 and the second reinforcement part 16k1 are welded to the Z-direction rear surfaces of the holding part 14a and the holding part 14b.

Further, the fold lines FX5j1 to FX5k2 that extend in the X-direction are folded in a valley form, and the fold parts 15j2, 15j3, 15k2, and 15k3 are caused to come into contact with Y-direction end portions of the holding part 14a and the holding part 14b and are then welded. Thereby, the pouch cell 10 is manufactured.

According to the present embodiment, similarly to another example of the fifth embodiment, it is possible to prevent peeling of the exterior film 13 in the vicinity of the boundary between the triangular column part 14c and the holding part 14a and between the triangular column part 14d and the holding part 14b. At the same time, by the fold parts 15j2, 15j3, 15k2, and 15k3, it is possible to improve the strength and the airtightness at the Y-direction end portion of the holding part 14a and the holding part 14b.

The Z-direction sizes in the adhered fold parts 15j2, 15j3, 15k2, and 15k3 are made larger than the Z-direction thickness size at the Y-direction end portions of the holding part 14a and the holding part 14b and are further overlapped with and adhered to the Z-direction rear surfaces of the holding part 14a and the holding part 14b, and it is possible to further improve the strength.

Further, in the present invention, it is possible to combine the configuration in each of the embodiments described above or employ a configuration in which a specific configuration is removed. For example, an example in which the fold parts 15a to 15d in the first embodiment are modified and combined with the fifth embodiment is the fold parts 15j2, 15j3, 15k2, and 15k3 in the sixth embodiment. In this way, individual configurations are not prevented from being combined separately.

Further, when it is desired to increase the thickness size of the holding part 14, the number of layers of the exterior film 13 adhered to the holding part 14 is increased, and when it is desired to decrease the thickness size of the holding part 14, the number of layers of the exterior film 13 adhered to the holding part 14 can be preferably reduced.

Utilization examples of the present invention include a battery cell that is specifically used for an on-vehicle application. Here, on-vehicle requirements must be able to withstand a wide range of disturbances such as a variety of climates, temperatures, altitudes, and vibrations due to a rough road or collision. Therefore, a high level of anti-water or anti-gas permeability from the atmosphere and anti-vibration property is required compared to a general consumer use.

However, with respect to consumer use, the utilization examples of the present invention specifically include an exterior package for foods that require long-term storage.

In this case, the examples include a case in which the foods are held by using the welded part such as a case in which the foods are hung and displayed by a hole opened in the welded part.

What is claimed is:

1. A pouch cell, comprising:
a storage discharge element having a substantially cuboid shape;
a power collection tab lead that is thinner than the storage discharge element and is externally drawn from the storage discharge element; and
an exterior film that packages the storage discharge element in a state where the power collection tab lead is externally drawn,
wherein the exterior film includes: a holding part that sandwiches the power collection tab lead from front and rear surfaces in a thickness direction; a fold part along an outline of the holding part; and a reinforcement part that is folded from the fold part and is joined to at least the holding part,
the fold part is joined to a side portion that extends in a thickness direction of the holding part,
the reinforcement part is folded back in a direction of sandwiching the power collection tab lead by the fold part, and
the reinforcement part includes an extension portion that extends from the fold part along a drawn direction of the power collection tab lead or a direction that crosses the drawn direction.

2. The pouch cell according to claim 1,
wherein the reinforcement part includes a second extension portion that is adhered to and closer to the storage discharge element than the holding part.

3. The pouch cell according to claim 1,
wherein a relief part that is separated from the power collection tab lead is formed on the reinforcement part near a boundary between the fold part and the extension portion such that close contact of the reinforcement part to the holding part is not blocked by the power collection tab lead that is drawn from the holding part.

4. The pouch cell according to claim 2,
wherein a relief part that is separated from the power collection tab lead is formed on the reinforcement part near a boundary between the fold part and the extension portion such that close contact of the reinforcement part to the holding part is not blocked by the power collection tab lead that is drawn from the holding part.

5. The pouch cell according to claim 1,
wherein the exterior film includes: a second fold part along an outline of the holding part; and a second reinforcement part that is folded from the second fold part and is joined to at least a surface of the holding part opposite to the reinforcement part,
the second fold part is joined to a side portion of the holding part that extends in a thickness direction, and
the second reinforcement part is folded in a direction of sandwiching the power collection tab lead by the second fold part.

6. The pouch cell according to claim 2,
wherein the exterior film includes: a second fold part along an outline of the holding part; and a second reinforcement part that is folded from the second fold part and is joined to at least a surface of the holding part opposite to the reinforcement part,
the second fold part is joined to a side portion of the holding part that extends in a thickness direction, and
the second reinforcement part is folded in a direction of sandwiching the power collection tab lead by the second fold part.

7. The pouch cell according to claim 3,
wherein the exterior film includes: a second fold part along an outline of the holding part; and a second reinforcement part that is folded from the second fold part and is joined to at least a surface of the holding part opposite to the reinforcement part,
the second fold part is joined to a side portion of the holding part that extends in a thickness direction, and
the second reinforcement part is folded in a direction of sandwiching the power collection tab lead by the second fold part.

8. The pouch cell according to claim 4,
wherein the exterior film includes: a second fold part along an outline of the holding part; and a second reinforcement part that is folded from the second fold part and is joined to at least a surface of the holding part opposite to the reinforcement part,
the second fold part is joined to a side portion of the holding part that extends in a thickness direction, and
the second reinforcement part is folded in a direction of sandwiching the power collection tab lead by the second fold part.
